(19) United States
(12) Patent Application Publication
(10) Pub. No.: US 2026/0037804 A1
(43) Pub. Date: Feb. 5, 2026

(54) CONSTRUCTING AN AUTOMATED TELECOMMUNICATIONS OPERATION MODEL

(71) Applicant: MICROSOFT TECHNOLOGY LICENSING, LLC, Redmond, WA (US)

(72) Inventors: Manikanta KOTARU, Kenmore, WA (US); Ganesh ANANTHANARAYANAN, Sammamish, WA (US); Sanjeev MEHROTRA, Kirkland, WA (US); Stefan SAROIU, Clyde Hill, WA (US); Paramvir BAHL, Bellevue, WA (US); Ryan Andrew BECKETT, Bellevue, WA (US)

(21) Appl. No.: 18/790,888

(22) Filed: Jul. 31, 2024

(51) Int. Cl. G06N 3/082

(52) U.S. Cl. CPC G06N 3/082

(57) ABSTRACT

The techniques disclosed herein provide a system for constructing an automated telecommunications network operation model prior to deployment in a telecommunications network for completing downstream tasks. In general, the performance of artificial intelligence agents such as large language models can degrade when applied to highly specific and/or complex domains such as telecommunications network operations resulting in erroneous outputs and potentially leading to network outages. As such, the present techniques finetune a large language model using a domain specific dataset to establish a specialized context directed to telecommunications network operations. That is, the large language model is pre-trained to establish the specialized context prior to deployment in the operation of a telecommunications network. In this way, the automated telecommunications network operation model can support a broad range of tasks within the context of a telecommunications network such as generating network configurations and question answering while also achieving strong performance.

### BACKGROUND

With the advent of advanced telecommunications network technologies such as fifth-generation cellular networks (5G) and beyond, network providers (e.g., telecommunications providers) have implemented complex, large-scale infrastructure to support such technologies. Consequently, the operational paradigm of telecommunications network tasks has likewise grown in complexity. For instance, generating network configurations is an oftentimes manual task that, with increasing complexity, can be prone to error leading to undesirable network outages. As such, many network providers have utilized automated language models such as artificial intelligence (AI) large language models (LLMs) to alleviate this technical burden. In various examples, a user (e.g., a technician, a system engineer) can submit a natural language user query instructing the automated language model to execute a certain task such as answering a question, generating network configuration settings, generating code, and so forth.

However, while such automated language models boast strong general linguistic performance such as basic word completion, question answering, and summarization, the performance of automated language models can suffer when applied to specific domains (e.g., telecommunications network operations). Examples of poor performance include erroneous outputs (e.g., invalid network configuration settings), increased latency (e.g., long processing times), and a lack of understanding on domain specific knowledge (e.g., certain technical standards). To that end, some network providers aim to alleviate these performance issues by including supplemental information in addition to the natural language user query. In a specific example, a natural language user query instructing the automated language model to generate network configuration settings in accordance with a certain technical standard includes the specification for the technical standard to provide the automated language model with sufficient contextual information to correctly complete the specified task.

Unfortunately, providing contextual information on a per-query basis can lead to several technical challenges. In one example, the volume of contextual information for a highly specific and/or complex domain (e.g., telecommunication network operations) can be large leading to input queries that far exceed the limitations of the automated language model. For instance, a large language model may define a limit to the size of input queries to prevent excessive resource consumption and/or latency (e.g., 128,000 tokens) thereby rendering many input queries with contextual information, which can include millions of tokens, infeasible.

It is with respect to these and other considerations that the disclosure made herein is presented.

### SUMMARY

The techniques disclosed herein provide a system for constructing an automated telecommunications network operation model prior to deployment in a telecommunications network for completing downstream tasks. In various examples, the automated telecommunications network operation model can also be generally referred to as a network operation model. As mentioned above, the performance of automated language models can degrade when applied to highly specific and/or complex domains such as telecommunications network operations resulting in erroneous outputs leading to potential network outages. Moreover, while many existing approaches aim to alleviate such performance issues by including supplemental information in the input query, such methods can be operationally expensive due to the large volume of supplemental information required to sufficiently establish context. For example, many large language models define a maximum size for an input query in terms of tokens (e.g., words) to prevent excessive latency and/or computing resource consumption (e.g., 64 k tokens, 128 k tokens). Such limits can preclude attaching supplemental information to user queries as individual documents of supplemental may include tens of thousands or even millions of tokens.

In contrast, the present techniques provide a system for constructing an automated telecommunications network operation model by finetuning a large language model using a domain specific dataset to establish a specialized context directed to telecommunications network operations. That is, the domain-specific dataset is utilized to pre-train the large language model to establish the specialized context prior to deployment in the operation of a telecommunications network. In this way, the automated telecommunications network operation model can support a broad range of tasks within the context of a telecommunications network such as generating network configurations, source code generation, and question answering while also achieving strong performance (e.g., minimizing erroneous outputs).

Generally described, the proposed system first retrieves a domain-specific training dataset containing documents comprising unstructured telecommunications network information. Within the context of the present disclosure, unstructured information is any information that has not been explicitly formatted for computational processing. This is in contrast to structured information that is formatted in compliance with a specific schema such as labeled machine learning data. By including unstructured information, the domain-specific training dataset can support a diverse range of information such as text documents in various formats, image, audio, source code, and so forth.

In various examples, the domain-specific training dataset includes specifications for various telecommunications network standards such as Third Generation Partnership Project (3GPP) specifications for 5G standards and Institute of Electrical and Electronics Engineers (IEEE) 802.11 specifications for Wi-Fi standards. In this way, the domain-specific training dataset establishes a general context from which the automated telecommunications network operation model can draw technical knowledge thereby ensuring correctness.

In another example, the domain-specific training dataset includes examples of valid network configuration settings and code examples from a system repository. In this way, the domain-specific training dataset can demonstrate expected output behaviors and enable the proposed system to establish output constraints defining valid outputs of the automated telecommunications network operation model to further prevent erroneous outputs. For example, the domain-specific training dataset can demonstrate the range of possible values for configuring an internet protocol (IP) address. Consequently, the automated telecommunications network operation model can learn that values outside the established range are invalid (e.g., incorrect).

To enable the automated telecommunications network operation model to learn from the unstructured information of the domain-specific training dataset, the proposed system generates an automated telecommunications network operation model training structure in which the domain-specific training dataset is processed to generate a plurality of input-output training pairs. In one example, the documents of the domain-specific training dataset are parsed by a separate automated model to label the unstructured information for training. For instance, the separate automated model can parse an example set of network configuration settings to detect various sections such as network interface settings (e.g., ethernet settings), network address assignment configurations, domain name system (DNS) client configurations, and hostnames and tag each section accordingly. In this example, an input is the tag identifying a certain section (e.g., “network interface settings”, “DNS client configurations”) while a corresponding output is the content of the section identified by the tag.

In another example, the automated model processes the unstructured information of the domain-specific training dataset to automatically generate an open-ended natural language query to submit to the automated telecommunications network operation model. In response, the automated telecommunications network operation model generates a solution to the natural language query. For instance, the automated model queries the automated telecommunications network operation model on “how to change a given network configuration to a different IP address range.” Accordingly, the automated telecommunications network operation model reasons about the problem to determine a solution based on the information captured in the domain-specific training dataset. The generated solution can then be compared against a predetermined solution derived from the domain-specific training dataset to adjust the automated telecommunications network operation model and improve performance. In this way, rather than merely training the automated telecommunications network operation model to regurgitate information (e.g., in a question-answer setting), the automated telecommunications network operation model training structure enables the automated telecommunications network operation model to develop domain-specific reasoning abilities that enable high performance in complex tasks such as generating code implementing certain specifications, generating network configuration settings that conform to certain standards, and detecting anomalous network traffic.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1 is a block diagram of a system for constructing an automated telecommunications network operation model using a domain-specific training dataset.

FIG. 2 is a block diagram of a first example automated telecommunications network operation model training structure.

FIG. 3 is a block diagram of a second example automated telecommunications network operation model training structure.

FIG. 4 is a flow diagram showing aspects of a routine for constructing an automated telecommunications network operation model training structure.

FIG. 5 is a computer architecture diagram illustrating an illustrative computer hardware and software architecture for a computing system capable of implementing aspects of the techniques and technologies presented herein.

FIG. 6 is a diagram illustrating a distributed computing environment capable of implementing aspects of the techniques and technologies presented herein.

### DETAILED DESCRIPTION

The techniques disclosed herein provide a system for constructing an automated telecommunications network operation model by finetuning a large language model (LLM) using a domain-specific training dataset. As mentioned above, including supplemental domain-specific information with a user query during normal operations (e.g., a “live” environment) can be operational expensive or even infeasible due to limitations on the size of input queries. For instance, many large language models define a maximum size for input queries (e.g., 128 k tokens) to prevent excessive computing resource consumption and/or latency.

Unfortunately, in highly specific and/or complex contexts such as telecommunications network operations, a significant amount of supplemental information may be needed to ensure acceptable large language model performance (e.g., prevent erroneous outputs). For example, the supplemental information can include specifications of various technical standards, examples of valid network configurations, and code examples comprising tens of thousands or even millions of tokens. As such, the present techniques are to finetune a large language model using a domain-specific training dataset prior to deployment in a telecommunications network. In this way, the proposed system enables network operators to establish important technical context for the automated telecommunications network operation model while maintaining acceptable latency and computing resource consumption.

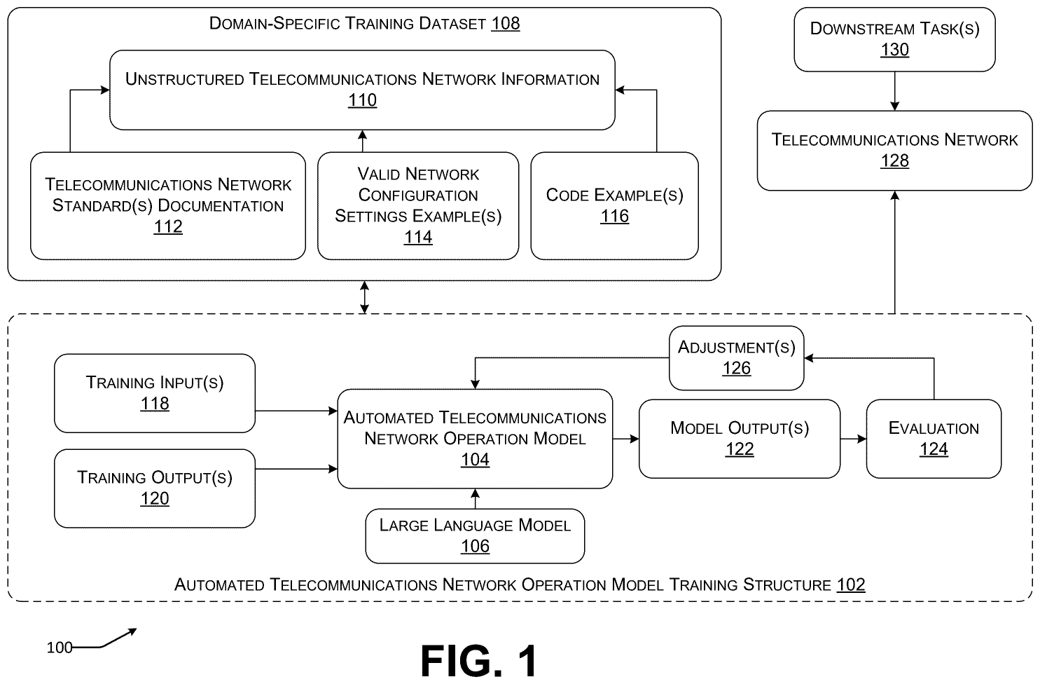

FIG. 1 illustrates a system 100 in which an automated telecommunications network operation model training structure 102 constructs an automated telecommunications network operation model 104 by finetuning a large language model 106 utilizing a domain-specific training dataset 108. Generally described, a large language model 106, unlike other artificial intelligence (AI) models, such as recurrent neural networks and long short-term memory (LSTM) models, large language models utilize a native self-attention mechanism to identify vague context from limited available data and even synthesize new content. Consequently, large language models are a strong candidate for automating tasks that are tedious and/or error-prone such as generating network configurations, code generation, anomalous traffic detection, as well as general tasks such as question answering.

As shown, the domain-specific training dataset 108 contains unstructured telecommunications network information 110. As mentioned above, unstructured information is any information that has not been explicitly formatted for computational processing. This is in contrast to structured information that is formatted in compliance with a specific schema such as labeled machine learning data. Consequently, the domain-specific training dataset 108 can include a broad range of information in various formats such as text documents, images, audio, source code, and so forth. For example, the domain-specific training dataset 108 includes documentation of one or more telecommunications network standards 112, examples of valid network configuration settings 114, and code examples 116 retrieved from a telecommunications network system repository. In a specific example, the domain-specific training dataset 108 is curated manually by a human expert (e.g., a technician, a system engineer). In an alternative example, the domain-specific training dataset 108 is automatically curated from a plurality of predefined sources such as well-known academic research publications, technical standards organizations (e.g., IEEE), online forums, and so forth.

In addition, the domain-specific training dataset 108 can be adjusted over time remove and/or add new information. For instance, a newly published academic research document can be added to the domain-specific training dataset 108. In another example, an updated technical standard (e.g., Wi-Fi 8 from Wi-Fi 7) can require a new version of the associated documentation 112 to be added to the domain-specific training dataset 108.

The unstructured telecommunications network information 110 of the domain-specific training dataset 108 is then processed to generate a plurality of training inputs 118 and a corresponding plurality of training outputs 120. Stated another way, the plurality of training inputs 118 and the plurality of training outputs 120 form a plurality of training input-output pairs. As will be described below, the training inputs 118 and training outputs 120 can be generated in various ways and consequently take various forms. In one example a training input 118 is a title of a document and/or a particular section of a document (e.g., a technical specification) such as “Physical channels and modulation”. As such, the corresponding the training output 120 is the content of the document and/or the particular section of the document.

In another example, the training input 118 is a natural language query defining a task and/or a question (e.g., “how do I change a given network configuration to a different IP address range?”). As such, the corresponding training output 120 is a solution to the task and/or question defined by the query that is derived from the unstructured telecommunications network information 110 of the domain-specific training dataset 108. In various examples, such a training output 120 is generated via an automated or semi-automated language model (e.g., a separate large language model). In this way, the query realistically mimics real-life user-defined tasks (e.g., network configuration tasks).

Accordingly, providing the training inputs 118 and the training outputs 120 to the large language model 106 transforms the general nature of the large language model 106 to the specific nature of the automated telecommunications network operation model 104. As such, the automated telecommunications network operation model 104 generates a model output 122 in response to a given training input 118. In response, the automated telecommunications network operation model training structure 102 generates an evaluation 124 based on a comparison between the model outputs 122 and the training output 120 that corresponds to the given training input 118. Consider again the example of a training input 118 asking “how do I change a given network configuration to a different IP address range?” The model output 122 for such a training input 118 can be a description of a process for changing a network configuration to a different IP address range that is based on the automated telecommunications network operation model's 104 current understanding of the unstructured telecommunications network information 110.

However, the evaluation 124 may determine that the solution offered by the model output 122 is inaccurate or incorrect based on the training output 120 (e.g., the ground truth). For instance, at the present training progress the automated telecommunications network operation model 104 may describe a solution that appears plausible at first glance but upon a review of the telecommunications network standard documentation 112 is actually inaccurate or incorrect within the specific telecommunications context (e.g., a hallucination). In response to such an evaluation 124, the automated telecommunications network operation model training structure 102 can apply one or more adjustments 126 to the automated telecommunications network operation model 104 to improve performance within the technical context of telecommunications networks. In various examples, the adjustments 126 modify some aspect of the automated telecommunications network operation model 104 such as adding a new parameter, modifying a specific layer of the automated telecommunications network operation model 104, and/or a full-scale adjustment to the entire automated telecommunications network operation model 104. In this way, the automated telecommunications network operation model 104 is iteratively improved over time to develop a strong understanding of the domain-specific training dataset 108.

Accordingly, the automated telecommunications network operation model 104 is then deployed to a telecommunications network 128 (e.g., a “live” environment) for executing various downstream tasks 130, also known as user-defined tasks. In one example, the downstream task 130 is a natural language user query requesting the automated telecommunications network operation model 104 to generate network configuration settings for a specific use case (e.g., an enterprise network serving a fleet of employee devices). In response, the automated telecommunications network operation model 104 can generate a network configuration in accordance with the specific technical context of the domain-specific training dataset 108 resulting in network configuration settings that are (1) valid and (2) exhibit the desired behavior described by the user query.

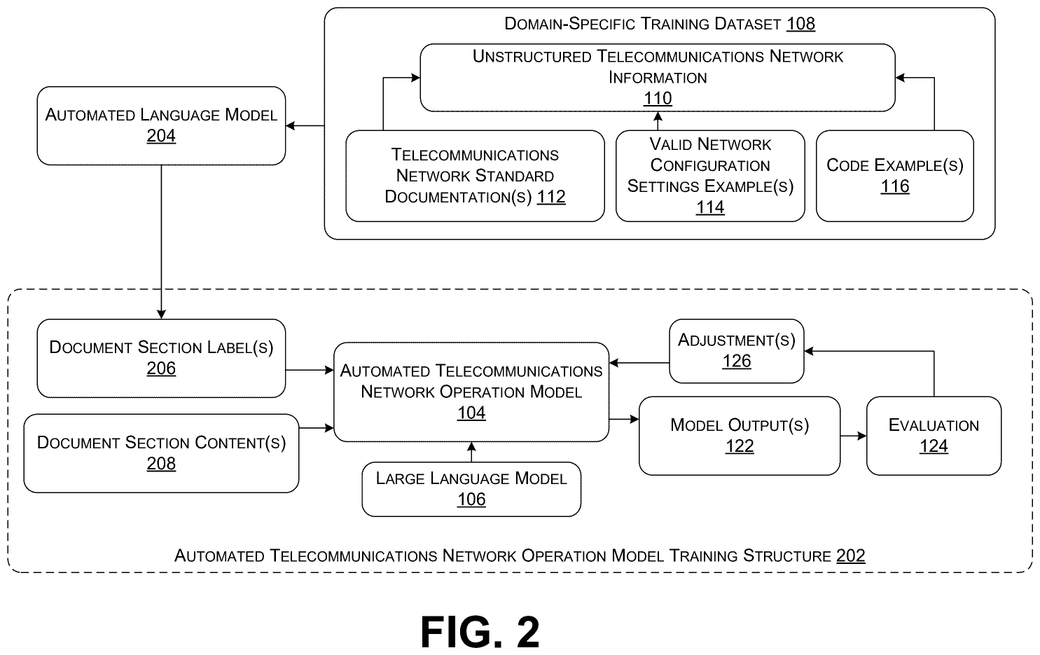

Turning now to FIG. 2, aspects of an example operational flow for constructing an automated telecommunications network operation model training structure 202 are shown and described. Utilizing the domain-specific training dataset 108 described above, an automated language model 204 generates a plurality of document section labels 206 and a corresponding plurality of document section contents 208. As mentioned above, the plurality of document section labels 206 and corresponding plurality of document section contents 208 are examples of training inputs and training outputs respectively. In various examples, the automated language model 204 is a large language model that is separate and different from the large language model 106 that is finetuned to construct the automated telecommunications network operation model 104.

For example, one input-output pair comprising a document section label 206 and a document section content 208 can be derived from a telecommunications network standard documentation 112 (e.g., a technical specification) in which the document section label 206 identifies a specific portion of the telecommunications network standard documentation 112 and the document section content 208 is the information of that specific portion of the telecommunications network standard documentation 112 (e.g., text describing a valid IP address range). Accordingly, the automated language model 204 utilizes the document section labels 206 and the document section contents 208 to generate the automated telecommunications network operation model training structure 202. Similar to the examples discussed above with respect to FIG. 1, the document section labels 206 and the document section contents 208 are provided to a large language model 106 to construct an automated telecommunications network operation model 104.

More specifically, the large language model 106 is trained to form associations between the document section labels 206 and the information captured by the document section contents 208. In a specific example, a document section label 206 identifies a section of the IEEE 802.11 specification directed to a spectral mask defining a permitted power distribution across each channel. Accordingly, the corresponding document section content 208 can specify that the spectral mask requires a radio signal to be attenuated a minimum of twenty decibels from its peak amplitude at eleven megahertz in each direction from the center frequency. In this way, the automated telecommunications network operation model 104 can effectively learn the unstructured telecommunications network information 110 of the domain-specific training dataset 108, analogous to rote memorization associating specific information with various concepts.

To enable the automated telecommunications network operation model 104 to form such associations, the automated telecommunications network operation model training structure 202 evaluates the model outputs 122 at various stages of training. For instance, during an initial training phase, the automated telecommunications network operation model 104 may generate inaccurate, incorrect, or nonsensical model outputs 122. Such errors can be detected via an evaluation 124 generated by the automated telecommunications network operation model training structure 202 based on a comparison of the model outputs 122 against the corresponding document section content 208. Accordingly, the automated telecommunications network operation model training structure 202 applies various adjustments 126 to the automated telecommunications network operation model 104 similar to the examples described above to improve model performance. In this way, the automated telecommunications network operation model 104 iteratively learns the specific information of the domain-specific training dataset 108 to establish the specific technical context mentioned above.

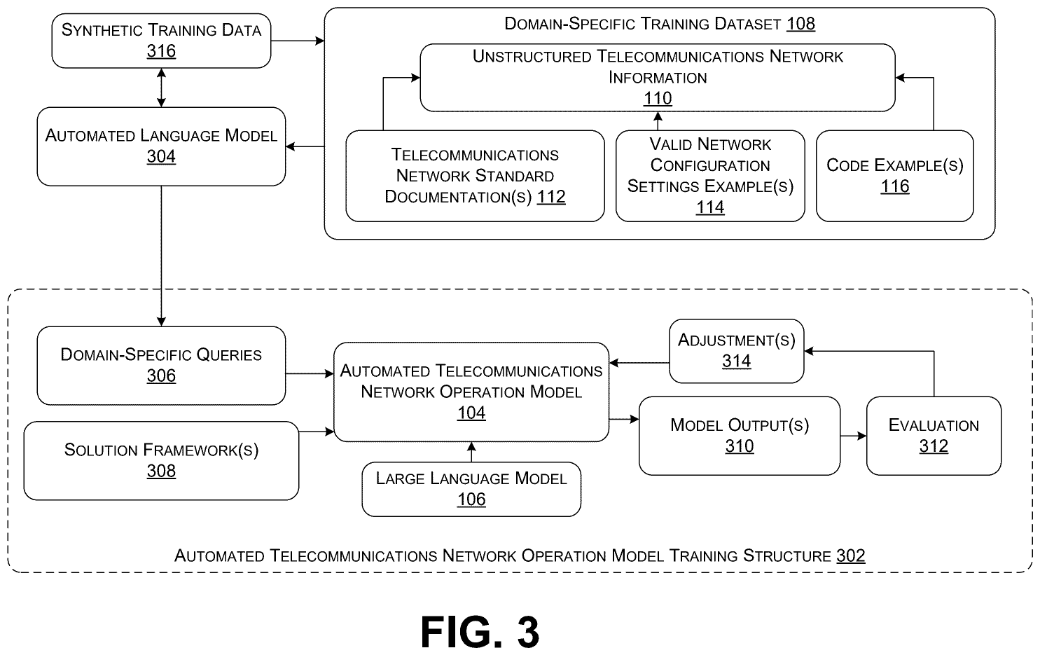

Turning now to FIG. 3, another example of operational flow for constructing an automated telecommunications network operation model training structure 302 is shown and described. Utilizing the domain-specific training dataset 108 described above, an automated language model 304 generates a plurality of domain-specific queries 306 and a corresponding plurality of solution frameworks 308 based on the unstructured telecommunication network information 110 such as documentation 112 of one or more telecommunications network standards, examples 114 of valid network configuration settings, code examples 116 from a telecommunications network system repository, published academic research documents, online discussions, and so forth. In a specific example, a domain-specific query 306 is a natural language question asking, “how do I change this network configuration to a different IP address range?” Accordingly, the corresponding solution framework 308 describes a process for modifying the IP address range of a given network configuration that is likewise derived from the domain-specific training dataset 108.

Subsequently, the automated language model 304 generates the automated telecommunications network operation model training structure 302 using the domain-specific queries 306 and the corresponding solution frameworks 308. Firstly, the automated language model 304 inputs a domain-specific query 306 defining a telecommunications network task (e.g., “how do I change this network configuration to a different IP address range?”) to the automated telecommunications network operation model 104. In response, the automated telecommunications network operation model 104 generates a model output 310 describing a process for completing the task defined by the domain-specific query 306.

In various examples, the model output 310 differs from the solution framework 308 which represents a “correct” approach in accordance with the domain-specific training dataset 108. For instance, during an initial training phase the model output 310 may propose a solution that is incompatible with the reality of the domain-specific training dataset 108 (e.g., invalid settings, nonexistent processes). Accordingly, the automated telecommunications network operation model training structure 302 can detect such errors via an evaluation 312 that includes a correctness of the model output 310 based on the solution framework 308 and a feasibility of the model output 310 based on various output constraints established by the domain-specific training dataset 108. For instance, the model output 310 may attempt to define an IP address that does not comply with possible values defined by the internet protocol standard. In response, the automated telecommunications network operation model training structure 302 applies one or more adjustments 314 to the automated telecommunications network operation model 104 to prevent such errors. In this way, the automated telecommunications network operation model 104 iteratively learns effective and correct approaches for accomplishing more complex downstream telecommunications network tasks beyond providing information in a question-answer setting. For the sake of clarity, and similar to the above example, the automated language model 304 can be a large language model that is separate and different from the large language model 106 that is finetuned to construct the automated telecommunications network operation model 104.

In addition, the automated language model 304 can be configured to generate synthetic training data 316 to further finetune the automated telecommunications network operation model 104 and/or expand the domain-specific training dataset 108. In a specific example, a system operator may determine that the domain-specific training dataset 108 does not include a sufficient number of valid network configuration settings examples 114. As such, the automated language model 304 can be configured to generate synthetic training data 316 based on the unstructured telecommunications network information 110 containing more examples of valid network configuration settings 114.

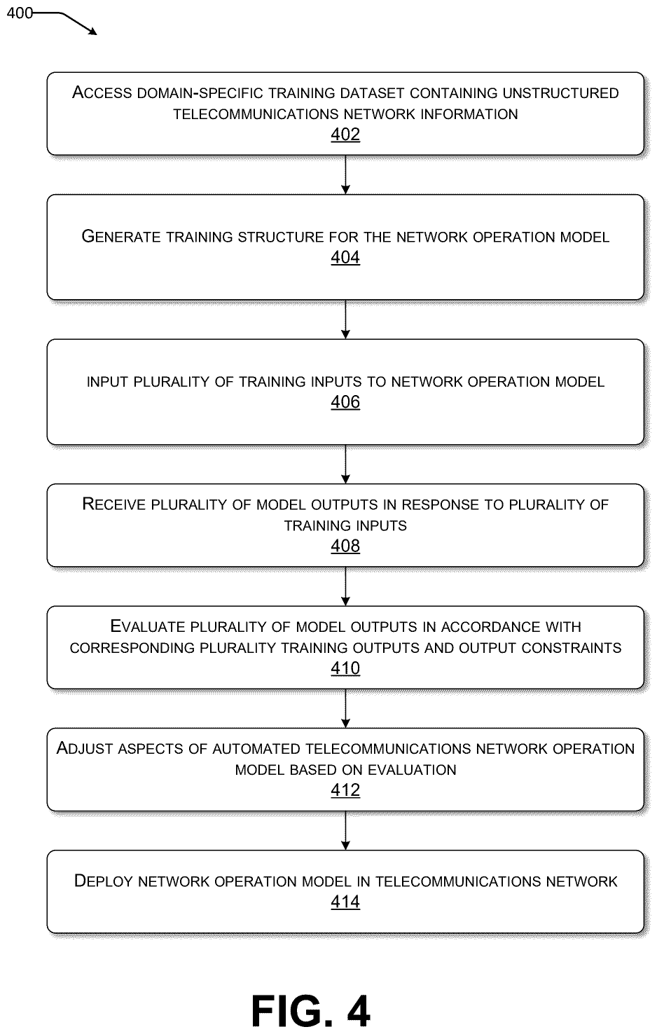

Proceeding now to FIG. 4, a process 400 for constructing a network operation model by finetuning a foundation model utilizing a domain specific dataset to establish a specialized context directed to telecommunications network operations, the specialized context enabling the network operation model to execute user-defined tasks in a telecommunications network, is shown and described. With respect to FIG. 4, the process 400 begins at operation 402 in which a system accesses or receives a domain-specific training dataset containing unstructured telecommunications network information. As mentioned above, the domain-specific training dataset can include documentation of one or more telecommunications network standards, examples of valid network configuration settings, code examples from a telecommunications network system repository, published academic research documents, online discussions, and the like.

Then, at operation 404, the system generates an automated telecommunications network operation model training structure comprising a plurality of training inputs and a corresponding plurality of training outputs based on the domain-specific training dataset and which defines one or more output constraints based on the domain-specific training dataset. In various examples, the training inputs are labels for sections of a document with the corresponding training outputs being the actual content of the sections of the document. In another example, the training inputs are natural language queries defining some task to accomplish and/or question to answer with the corresponding training outputs satisfying the natural language queries (e.g., an answer to a question, a generated network configuration file). Moreover, the output constraints can be any technical value that is defined by the domain-specific training dataset such as valid IP address ranges, possible values for a subnet mask, valid hostnames, and so forth. In this way, the output constraints prevent the automated telecommunications network operation model from violating the technical regulations captured by the domain-specific training dataset.

Next, at operation 406, the system provides the plurality of training inputs to the automated telecommunications network operation model within the automated telecommunications network operation model training structure.

Subsequently, at operation 408, the automated telecommunications network operation model training structure receives a plurality of model outputs from the automated telecommunications network operation model in response to the plurality of training inputs.

Then, at operation 410, the automated telecommunications network operation model training structure evaluates the plurality of model outputs in accordance with the corresponding plurality of training outputs. In various examples, the automated telecommunications network operation model training structure's evaluations determines a correctness of the model outputs based on the plurality of training outputs and a feasibility of the model outputs based on the output constraints.

Next, at operation 412, the automated telecommunications network operation model training structure adjusts one or more aspects of the automated telecommunications network operation model based on the evaluation. In various examples, the adjustments modify one or more of the layers of the automated telecommunications network operation model. In another example, the adjustments add and/or remove parameters from the automated telecommunications network operation model.

Finally, at operation 414, after being fully trained on the domain-specific training dataset, the automated telecommunications network operation model is deployed in the telecommunications network for automatically executing user-defined tasks in the telecommunications network. In an embodiment, the user-defined tasks include a natural language query instructing the network operation model to execute one or more actions such as generating network configuration settings, generating code, answering questions, addressing anomalous network traffic and so forth.

For ease of understanding, the process discussed in this disclosure is delineated as separate operations represented as independent blocks. However, these separately delineated operations should not be construed as necessarily order dependent in their performance. The order in which the process is described is not intended to be construed as a limitation, and any number of the described process blocks may be combined in any order to implement the process or an alternate process. Moreover, it is also possible that one or more of the provided operations is modified or omitted.

The particular implementation of the technologies disclosed herein is a matter of choice dependent on the performance and other requirements of a computing device. Accordingly, the logical operations described herein are referred to variously as states, operations, structural devices, acts, or modules. These states, operations, structural devices, acts, and modules can be implemented in hardware, software, firmware, in special-purpose digital logic, and any combination thereof. It should be appreciated that more or fewer operations can be performed than shown in the figures and described herein. These operations can also be performed in a different order than those described herein.

It also should be understood that the illustrated method can end at any time and need not be performed in its entirety. Some or all operations of the method, and/or substantially equivalent operations, can be performed by execution of computer-readable instructions included on a computer-storage media, as defined below. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the process 400 can be implemented, at least in part, by modules running the features disclosed herein can be a dynamically linked library (DLL), a statically linked library, functionality produced by an application programing interface (API), a compiled program, an interpreted program, a script, or any other executable set of instructions. Data can be stored in a data structure in one or more memory components. Data can be retrieved from the data structure by addressing links or references to the data structure.

Although the illustration may refer to the components of the figures, it should be appreciated that the operations of the process 400 may also be implemented in other ways. In addition, one or more of the operations of the process 400 may alternatively or additionally be implemented, at least in part, by a chipset working alone or in conjunction with other software modules. In the example described below, one or more modules of a computing system can receive and/or process the data disclosed herein. Any service, circuit, or application suitable for providing the techniques disclosed herein can be used in operations described herein.

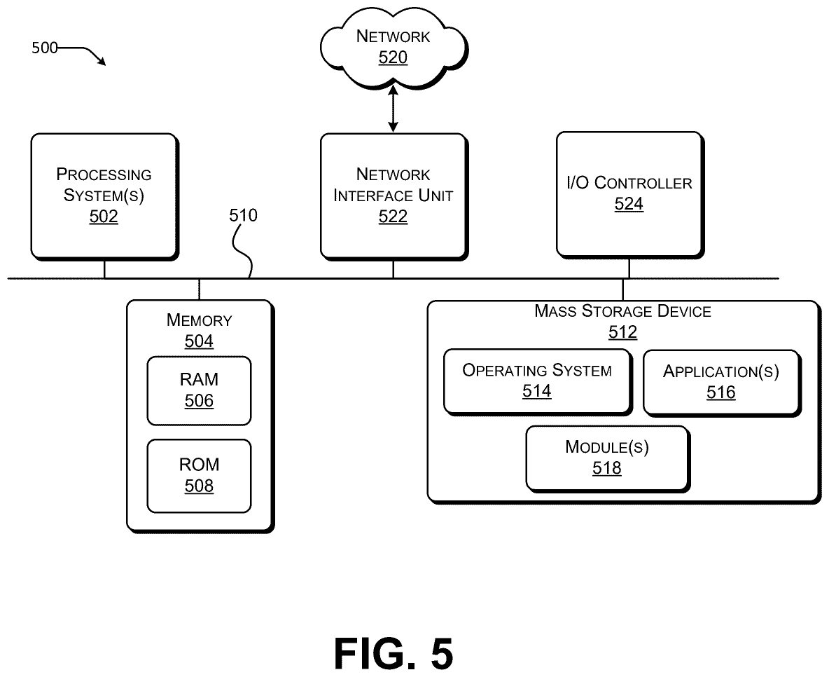

FIG. 5 shows additional details of an example computer architecture 500 for a device, capable of executing computer instructions (e.g., a module or a program component described herein). The computer architecture 500 illustrated in FIG. 5 includes processing system 502, a system memory 504, including a random-access memory 506 (RAM) and a read-only memory (ROM) 508, and a system bus 510 that couples the memory 504 to the processing system 502. The processing system 502 comprises processing unit(s). In various examples, the processing unit(s) of the processing system 502 are distributed. Stated another way, one processing unit of the processing system 502 may be located in a first location (e.g., a rack within a datacenter) while another processing unit of the processing system 502 is located in a second location separate from the first location. Moreover, the systems discussed herein can be provided as a distributed computing system such as a cloud service.

Processing unit(s), such as processing unit(s) of processing system 502, can represent, for example, a CPU-type processing unit, a GPU-type processing unit, a field-programmable gate array (FPGA), another class of digital signal processor (DSP), or other hardware logic components that may, in some instances, be driven by a CPU. For example, illustrative types of hardware logic components that can be used include Application-Specific Integrated Circuits (ASICs), Application-Specific Standard Products (ASSPs), System-on-a-Chip Systems (SOCs), Complex Programmable Logic Devices (CPLDs), and the like.

A basic input/output system containing the basic routines that help to transfer information between elements within the computer architecture 500, such as during startup, is stored in the ROM 508. The computer architecture 500 further includes a mass storage device 512 for storing an operating system 514, application(s) 516, modules 518, and other data described herein.

The mass storage device 512 is connected to processing system 502 through a mass storage controller connected to the bus 510. The mass storage device 512 and its associated computer-readable media provide non-volatile storage for the computer architecture 500. Although the description of computer-readable media contained herein refers to a mass storage device, the computer-readable media can be any available computer-readable storage media or communication media that can be accessed by the computer architecture 500.

Computer-readable media includes computer-readable storage media and/or communication media. Computer-readable storage media includes one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including RAM, static RAM (SRAM), dynamic RAM (DRAM), phase change memory (PCM), ROM, erasable programmable ROM (EPROM), electrically EPROM (EEPROM), flash memory, compact disc read-only memory (CD-ROM), digital versatile disks (DVDs), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device.

In contrast to computer-readable storage media, communication media can embody computer-readable instructions, data structures, program modules, or other data in a modulated data signal, such as a carrier wave, or other transmission mechanism. As defined herein, computer storage media does not include communication media. That is, computer-readable storage media does not include communications media consisting solely of a modulated data signal, a carrier wave, or a propagated signal, per se.

According to various configurations, the computer architecture 500 may operate in a networked environment using logical connections to remote computers through the network 520. The computer architecture 500 may connect to the network 520 through a network interface unit 522 connected to the bus 510. The computer architecture 500 also may include an input/output controller 524 for receiving and processing input from a number of other devices, including a keyboard, mouse, touch, or electronic stylus or pen. Similarly, the input/output controller 524 may provide output to a display screen, a printer, or other type of output device.

The software components described herein may, when loaded into the processing system 502 and executed, transform the processing system 502 and the overall computer architecture 500 from a general-purpose computing system into a special-purpose computing system customized to facilitate the functionality presented herein. The processing system 502 may be constructed from any number of transistors or other discrete circuit elements, which may individually or collectively assume any number of states. More specifically, the processing system 502 may operate as a finite-state machine, in response to executable instructions contained within the software modules disclosed herein. These computer-executable instructions may transform the processing system 502 by specifying how the processing system 502 transition between states, thereby transforming the transistors or other discrete hardware elements constituting the processing system 502.

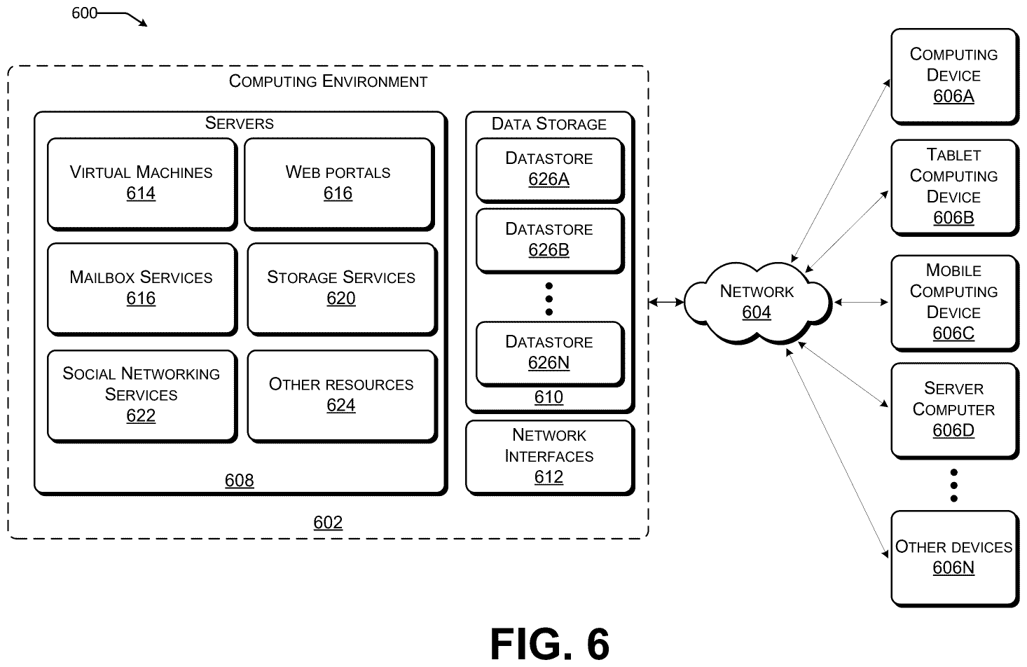

FIG. 6 depicts an illustrative distributed computing environment 600 capable of executing the software components described herein. Thus, the distributed computing environment 600 illustrated in FIG. 6 can be utilized to execute any aspects of the software components presented herein. For example, the distributed computing environment 600 can be utilized to execute aspects of the software components described herein. Accordingly, the distributed computing environment 600 can include a computing environment 602 operating on, in communication with, or as part of the network 604. The network 604 can include various access networks. One or more client devices 606A-606N (hereinafter referred to collectively and/or generically as “computing devices 606”) can communicate with the computing environment 602 via the network 604. In one illustrated configuration, the computing devices 606 include a computing device 606A such as a laptop computer, a desktop computer, or other computing device; a slate or tablet computing device (“tablet computing device”) 606B; a mobile computing device 606C such as a mobile telephone, a smart phone, or other mobile computing device; a server computer 606D; and/or other devices 606N. It should be understood that any number of computing devices 606 can communicate with the computing environment 602.

In various examples, the computing environment 602 includes servers 608, data storage 610, and one or more network interfaces 612. The servers 608 can host various services, virtual machines, portals, and/or other resources. In the illustrated configuration, the servers 608 host virtual machines 614, Web portals 616, mailbox services 618, storage services 620, and/or social networking services 622. As shown in FIG. 6 the servers 608 also can host other services, applications, portals, and/or other resources (“other resources”) 624.

As mentioned above, the computing environment 602 can include the data storage 610. According to various implementations, the functionality of the data storage 610 is provided by one or more databases operating on, or in communication with, the network 604. The functionality of the data storage 610 also can be provided by one or more servers configured to host data for the computing environment 600. The data storage 610 can include, host, or provide one or more real or virtual datastores 626A-626N (hereinafter referred to collectively and/or generically as “datastores 626”). The datastores 626 are configured to host data used or created by the servers 808 and/or other data. That is, the datastores 626 also can host or store web page documents, word documents, presentation documents, data structures, algorithms for execution by a recommendation engine, and/or other data utilized by any application program. Aspects of the datastores 626 may be associated with a service for storing files.

The computing environment 602 can communicate with, or be accessed by, the network interfaces 612. The network interfaces 612 can include various types of network hardware and software for supporting communications between two or more computing devices including the computing devices and the servers. It should be appreciated that the network interfaces 612 also may be utilized to connect to other types of networks and/or computer systems.

It should be understood that the distributed computing environment 600 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 600 provides the software functionality described herein as a service to the computing devices. It should be understood that the computing devices can include real or virtual machines including server computers, web servers, personal computers, mobile computing devices, smart phones, and/or other devices. As such, various configurations of the concepts and technologies disclosed herein enable any device configured to access the distributed computing environment 600 to utilize the functionality described herein for providing the techniques disclosed herein, among other aspects.

The disclosure presented herein also encompasses the subject matter set forth in the following clauses.

Example Clause A, a method for constructing a network operation model by finetuning a foundation model utilizing a domain-specific dataset to establish a specialized context directed to telecommunications network operations, the specialized context enabling the network operation model to execute user-defined tasks in a telecommunications network, the method comprising: accessing, by a computing system, the domain-specific training dataset containing unstructured telecommunications network information comprising documentation of one or more telecommunications network standards, one or more examples of valid network configuration settings, and one or more code examples from a system repository of the telecommunications network; generating, by the computing system, a training structure for the network operation model wherein: the training structure comprises a plurality of training inputs and a corresponding plurality of training outputs based on the domain-specific training dataset; and the training structure defines one or more output constraints based on the domain-specific training dataset, wherein the output constraints define valid outputs of the network operation model; inputting the plurality of training inputs to the network operation model; receiving, from the network operation model, a plurality of model outputs in response to the plurality of training inputs; evaluating the plurality of model outputs in accordance with the corresponding plurality of training outputs and the output constraints of the training structure for the network operation model; adjusting one or more aspects of the network operation model based on the evaluating; and deploying the network operation model in the telecommunications network to automatically execute user-defined network configuration tasks in the telecommunications network, wherein the user-defined network configuration task includes a natural language query instructing the network operation model to execute one or more actions.

Example Clause B, the method of Example Clause A, wherein: the user-defined network configuration task is an anomaly detection task; the natural language query instructs the network operation model to detect anomalous network traffic indicating a security issue within the telecommunications network; and the network operation model generates a network configuration setting that resolves the security issue.

Example Clause C, the method of Example Clause A or Example Clause B, wherein the unstructured telecommunications networking information of the domain-specific dataset further comprises one or more academic research documents.

Example Clause D, the method of any one of Example Clause A through C, wherein the training structure for the network operation model is generated by an automated language model, the method further comprising: parsing, by the automated telecommunications network operation language model, a document of the domain-specific training dataset; assigning a label to each of a plurality of sections within the document wherein: the label identifying an individual section of the plurality of sections defines an input of the plurality of training inputs of the training structure network operation model; and a content of the individual section identified by the label defines a corresponding output of the plurality of training outputs of the training structure for the network operation model.

Example Clause E, the method of any one of Example Clause A through D, wherein the training structure for the network operation model is generated by an automated language model, the method further comprising: generating, by the automated telecommunications network operation language model, a natural language query based on the unstructured telecommunications networking information of the domain-specific training dataset wherein: the natural language query is an input of the plurality of training inputs of the training structure network operation model; and a solution to the natural language query is a corresponding output of the plurality of training outputs of the training structure network operation model.

Example Clause F, the method of any one of Example Clause A through E, wherein evaluating the plurality of model outputs in accordance with the corresponding plurality of training outputs and the output constraints of the training structure network operation model comprises: determining a correctness of the each of the plurality of model outputs based on the corresponding plurality of training outputs; and determining a feasibility of each of the plurality of model outputs based on the output constraints.

Example Clause G, the method of any one of Example Clause A through F, wherein adjusting one or more parameters of the network operation model comprises a modification to one or more layers of the network operation model.

Example Clause H, wherein adjusting one or more aspects of the network operation model comprises a modification to one or more parameters of the network operation model.

Example Clause I, a system for constructing an automated telecommunications network operation model for executing downstream tasks in a telecommunications network, the system comprising: a processing system; and a computer-readable medium having encoded thereon computer-readable instructions that when executed by the processing system causes the system to perform operations comprising: receiving a domain-specific training dataset contains unstructured telecommunications network information comprising documentation of one or more telecommunications network standards, one or more examples of valid network configuration settings, and one or more code examples from a system repository of the telecommunications network; generating an training structure for the automated telecommunications network operation model wherein: the training structure comprises a plurality of training inputs and a corresponding plurality of training outputs based on the domain-specific training dataset; and the training structure defines one or more output constraints based on the domain-specific training dataset wherein the output constraints define valid outputs of the automated telecommunications network operation model; providing the plurality of training inputs to the automated telecommunications network operation model; receiving, from the automated telecommunications network operation model, a plurality of model outputs in response to the plurality of training inputs; evaluating the plurality of model outputs in accordance with the corresponding plurality of training outputs and the output constraints of the training structure for the automated telecommunications network operation mode; adjusting one or more aspects of the automated telecommunications network operation model based on the evaluating; and deploying the automated telecommunications network operation model in the telecommunications network for executing downstream tasks.

Example Clause J, the system of Example Clause I, wherein the unstructured telecommunications networking information of the domain-specific dataset further comprises one or more academic research documents.

Example Clause K, the system of Example Clause I or Example Clause J, wherein the training structure for the automated telecommunications network operation model is generated by an automated language model, the operations further comprising: parsing, by the automated telecommunications network operation language model, a document of the domain-specific training dataset; assigning a label to each of a plurality of sections within the document wherein: the label identifying an individual section of the plurality of sections defines an input of the plurality of training inputs of the training structure; and a content of the individual section identified by the label defines a corresponding output of the plurality of training outputs of the training structure.

Example Clause L, the system of any one of Example Clause I through K, wherein the training structure for the automated telecommunications network operation model is generated by an automated language model, the operations further comprising: generating, by the automated telecommunications network operation language model, a natural language query based on the unstructured telecommunications networking information of the domain-specific training dataset wherein: the natural language query is an input of the plurality of training inputs of the training structure; and a solution to the natural language query is a corresponding output of the plurality of training outputs of the training structure.

Example Clause M, the system of any one of Example I through L, wherein evaluating the plurality of model outputs in accordance with the corresponding plurality of training outputs and the output constraints of the training structure for the automated telecommunications network operation model comprises: determining a correctness of the each of the plurality of model outputs based on the corresponding plurality of training outputs; and determining a feasibility of each of the plurality of model outputs based on the output constraints.

Example Clause N, the system of any one of Example Clause I through M, wherein adjusting one or more parameters of the automated telecommunications network operation model comprises a modification to one or more layers of the automated telecommunications network operation model.

Example Clause O, the system of any one of Example Clause I through N, wherein adjusting one or more aspects of the automated telecommunications network operation model comprises a modification to one or more parameters of the automated telecommunications network operation model.

Example Clause P, a computer-readable storage medium for constructing an automated telecommunications network operation model for executing downstream tasks in a telecommunications network, the computer-readable storage medium having encoded thereon computer-readable instructions that when executed by a system causes the system to execute operations comprising: receiving a domain-specific training dataset contains unstructured telecommunications network information comprising documentation of one or more telecommunications network standards, one or more examples of valid network configuration settings, and one or more code examples from a system repository of the telecommunications network; generating a training structure for the automated telecommunications network operation model wherein: the training structure comprises a plurality of training inputs and a corresponding plurality of training outputs based on the domain-specific training dataset; and the training structure defines one or more output constraints based on the domain-specific training dataset wherein the output constraints define valid outputs of the automated telecommunications network operation model; providing the plurality of training inputs to the automated telecommunications network operation model; receiving, from the automated telecommunications network operation model, a plurality of model outputs in response to the plurality of training inputs; evaluating the plurality of model outputs in accordance with the corresponding plurality of training outputs and the output constraints of the training structure for the telecommunications network operation model; adjusting one or more aspects of the automated telecommunications network operation model based on the evaluating; and deploying the automated telecommunications network operation model in the telecommunications network for executing downstream tasks.

Example Clause Q, the computer-readable storage medium of Example Clause O or Example Clause P, wherein the training structure for the automated telecommunications network operation model is generated by an automated language model, the operations further comprising: parsing, by the automated telecommunications network operation language model, a document of the domain-specific training dataset; assigning a label to each of a plurality of sections within the document wherein: the label identifying an individual section of the plurality of sections defines an input of the plurality of training inputs of the training structure; and a content of the individual section identified by the label defines a corresponding output of the plurality of training outputs of the training structure.

Example Clause R, the computer-readable storage medium of any one of Example Clause O through Q, wherein the training structure for the automated telecommunications network operation model is generated by an automated language model, the operations further comprising: generating, by the automated telecommunications network operation language model, a natural language query based on the unstructured telecommunications networking information of the domain-specific training dataset wherein: the natural language query is an input of the plurality of training inputs of the training structure; and a solution to the natural language query is a corresponding output of the plurality of training outputs of the training structure.

Example Clause S, the computer-readable storage medium of any one of Example Clause O through R, wherein evaluating the plurality of model outputs in accordance with the corresponding plurality of training outputs and the output constraints of the training structure for the automated telecommunications network operation model comprises: determining a correctness of the each of the plurality of model outputs based on the corresponding plurality of training outputs; and determining a feasibility of each of the plurality of model outputs based on the output constraints.

Example Clause T, the computer-readable storage medium of any one of Example Clause O through S, wherein adjusting one or more parameters of the automated telecommunications network operation model comprises a modification to one or more layers of the automated telecommunications network operation model.

Conditional language such as, among others, “can,” “could,” “might” or “may,” unless specifically stated otherwise, are understood within the context to present that certain examples include, while other examples do not include, certain features, elements and/or steps. Thus, such conditional language is not generally intended to imply that certain features, elements and/or steps are in any way required for one or more examples or that one or more examples necessarily include logic for deciding, with or without user input or prompting, whether certain features, elements and/or steps are included or are to be performed in any particular example. Conjunctive language such as the phrase “at least one of X, Y or Z,” unless specifically stated otherwise, is to be understood to present that an item, term, etc. may be either X, Y, or Z, or a combination thereof.

The terms “a,” “an,” “the” and similar referents used in the context of describing the invention (especially in the context of the following claims) are to be construed to cover both the singular and the plural unless otherwise indicated herein or clearly contradicted by context. The terms “based on,” “based upon,” and similar referents are to be construed as meaning “based at least in part” which includes being “based in part” and “based in whole” unless otherwise indicated or clearly contradicted by context.

In addition, any reference to “first,” “second,” etc. elements within the Summary and/or Detailed Description is not intended to and should not be construed to necessarily correspond to any reference of “first,” “second,” etc. elements of the claims. Rather, any use of “first” and “second” within the Summary, Detailed Description, and/or claims may be used to distinguish between two different instances of the same element.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

1. A method for constructing a network operation model by finetuning a foundation model utilizing a domain-specific dataset to establish a specialized context directed to telecommunications network operations, the specialized context enabling the network operation model to execute user-defined tasks in a telecommunications network, the method comprising:
accessing, by a computing system, the domain-specific training dataset containing unstructured telecommunications network information comprising documentation of one or more telecommunications network standards, one or more examples of valid network configuration settings, and one or more code examples from a system repository of the telecommunications network;
generating, by the computing system, a training structure for the network operation model wherein:
the training structure comprises a plurality of training inputs and a corresponding plurality of training outputs based on the domain-specific training dataset; and
the training structure defines one or more output constraints based on the domain-specific training dataset, wherein the output constraints define valid outputs of the network operation model;
inputting the plurality of training inputs to the network operation model;
receiving, from the network operation model, a plurality of model outputs in response to the plurality of training inputs;
evaluating the plurality of model outputs in accordance with the corresponding plurality of training outputs and the output constraints of the training structure for the network operation model;
adjusting one or more aspects of the network operation model based on the evaluating; and
deploying the network operation model in the telecommunications network to automatically execute user-defined tasks in the telecommunications network, wherein the user-defined tasks include a natural language query instructing the network operation model to execute one or more actions.

2. The method of claim 1, wherein:
the user-defined network task is an anomaly detection task;
the natural language query instructs the network operation model to detect anomalous network traffic indicating a security issue within the telecommunications network; and
the network operation model generates a network setting that resolves the security issue.

3. The method of claim 1, wherein the unstructured telecommunications networking information of the domain-specific dataset further comprises one or more academic research documents.

4. The method of claim 1, wherein the training structure for the network operation model is generated by an automated language model, the method further comprising:
parsing, by the network operation model, a document of the domain-specific training dataset;
assigning a label to each of a plurality of sections within the document wherein:
the label identifying an individual section of the plurality of sections defines an input of the plurality of training inputs of the training structure for the network operation model; and
a content of the individual section identified by the label defines a corresponding output of the plurality of training outputs of the training structure for the network operation model.

5. The method of claim 1, wherein the training structure for the network operation model is generated by an automated language model, the method further comprising:
generating, by the network operation model, a natural language query based on the unstructured telecommunications networking information of the domain-specific training dataset wherein:
the natural language query is an input of the plurality of training inputs of the training structure for the network operation model; and
a solution to the natural language query is a corresponding output of the plurality of training outputs of the training structure for the network operation model.

6. The method of claim 1, wherein evaluating the plurality of model outputs in accordance with the corresponding plurality of training outputs and the output constraints of the training structure for the network operation model comprises:
determining a correctness of the each of the plurality of model outputs based on the corresponding plurality of training outputs; and
determining a feasibility of each of the plurality of model outputs based on the output constraints.

7. The method of claim 1, wherein adjusting one or more parameters of the network operation model comprises a modification to one or more layers of the network operation model.

8. The method of claim 1, wherein adjusting one or more aspects of the network operation model comprises a modification to one or more parameters of the network operation model.

9. A system for implementing an automated telecommunications network operation model for executing downstream tasks in a telecommunications network, the system comprising:
a processing system; and
a computer-readable medium having encoded thereon computer-readable instructions that when executed by the processing system causes the system to perform operations comprising:
receiving a domain-specific training dataset contains unstructured telecommunications network information comprising documentation of one or more telecommunications network standards, one or more examples of valid network configuration settings, and one or more code examples from a system repository of the telecommunications network;
generating a training structure for the automated telecommunications network operation model wherein:
the training structure comprises a plurality of training inputs and a corresponding plurality of training outputs based on the domain-specific training dataset; and
the training structure defines one or more output constraints based on the domain-specific training dataset wherein the output constraints define valid outputs of the automated telecommunications network operation model;
providing the plurality of training inputs to the automated telecommunications network operation model;
receiving, from the automated telecommunications network operation model, a plurality of model outputs in response to the plurality of training inputs;
evaluating the plurality of model outputs in accordance with the corresponding plurality of training outputs and the output constraints of the training structure for the automated telecommunications network operation model;
adjusting one or more aspects of the automated telecommunications network operation model based on the evaluating; and
deploying the automated telecommunications network operation model in the telecommunications network for automatically executing downstream tasks in the telecommunications network.

10. The system of claim 9, wherein the unstructured telecommunications networking information of the domain-specific dataset further comprises one or more academic research documents.

11. The system of claim 9, wherein the training structure for the automated telecommunications network operation model is generated by an automated language model, the operations further comprising:
parsing, by the automated telecommunications network operation model, a document of the domain-specific training dataset;
assigning a label to each of a plurality of sections within the document wherein:
the label identifying an individual section of the plurality of sections defines an input of the plurality of training inputs of the training structure; and
a content of the individual section identified by the label defines a corresponding output of the plurality of training outputs of the training structure.

12. The system of claim 9, wherein the training structure for the automated telecommunications network operation model is generated by an automated language model, the operations further comprising:
generating, by the automated telecommunications network operation model, a natural language query based on the unstructured telecommunications networking information of the domain-specific training dataset wherein:
the natural language query is an input of the plurality of training inputs of the training structure; and
a solution to the natural language query is a corresponding output of the plurality of training outputs of the training structure.

13. The system of claim 9, wherein evaluating the plurality of model outputs in accordance with the corresponding plurality of training outputs and the output constraints of the training structure for the automated telecommunications network operation model comprises:
determining a correctness of the each of the plurality of model outputs based on the corresponding plurality of training outputs; and
based on a threshold, determining a feasibility of each of the plurality of model outputs based on the output constraints.

14. The system of claim 9, wherein adjusting one or more parameters of the automated telecommunications network operation model comprises a modification to one or more layers of the automated telecommunications network operation model.

15. The system of claim 9, wherein adjusting one or more aspects of the automated telecommunications network operation model comprises a modification to one or more parameters of the automated telecommunications network operation model.

16. A computer-readable storage medium for constructing an automated telecommunications network operation model for executing downstream tasks in a telecommunications network, the computer-readable storage medium having encoded thereon computer-readable instructions that when executed by a system causes the system to execute operations comprising:
receiving a domain-specific training dataset contains unstructured telecommunications network information comprising documentation of one or more telecommunications network standards, one or more examples of valid network configuration settings, and one or more code examples from a system repository of the telecommunications network;
generating a training structure for the automated telecommunications network operation model wherein:
the training structure comprises a plurality of training inputs and a corresponding plurality of training outputs based on the domain-specific training dataset; and
the training structure defines one or more output constraints based on the domain-specific training dataset wherein the output constraints define valid outputs of the automated telecommunications network operation model;
providing the plurality of training inputs to the automated telecommunications network operation model;
receiving, from the automated telecommunications network operation model, a plurality of model outputs in response to the plurality of training inputs;
evaluating the plurality of model outputs in accordance with the corresponding plurality of training outputs and the output constraints of the training structure for the telecommunications network operation model;
adjusting one or more aspects of the automated telecommunications network operation model based on the evaluating; and
deploying the automated telecommunications network operation model in the telecommunications network for executing downstream tasks.

17. The computer-readable storage medium of claim 16, wherein the training structure for the automated telecommunications network operation model is generated by an automated language model, the operations further comprising:
parsing, by the automated telecommunications network operation model, a document of the domain-specific training dataset;
assigning a label to each of a plurality of sections within the document wherein:
the label identifying an individual section of the plurality of sections defines an input of the plurality of training inputs of the training structure; and
a content of the individual section identified by the label defines a corresponding output of the plurality of training outputs of the training structure.

18. The computer-readable storage medium of claim 16, wherein the training structure for the automated telecommunications network operation model is generated by an automated language model, the operations further comprising:
generating, by the automated telecommunications network operation model, a natural language query based on the unstructured telecommunications networking information of the domain-specific training dataset wherein:
the natural language query is an input of the plurality of training inputs of the training structure; and
a solution to the natural language query is a corresponding output of the plurality of training outputs of the training structure.

19. The computer-readable storage medium of claim 16, wherein evaluating the plurality of model outputs in accordance with the corresponding plurality of training outputs and the output constraints of the training structure for the automated telecommunications network operation model comprises:
determining a correctness of the each of the plurality of model outputs based on the corresponding plurality of training outputs; and
determining a feasibility of each of the plurality of model outputs based on the output constraints.

20. The computer-readable storage medium of claim 16, wherein adjusting one or more parameters of the automated telecommunications network operation model comprises a modification to one or more layers of the automated telecommunications network operation model.
